(19) United States
(12) Patent Application Publication
(10) Pub. No.: US 2004/0175221 A1
(43) Pub. Date: Sep. 9, 2004

(54) Printer

(75) Inventor: Toshiharu Sekino, Tagata-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: TOSHIBA TEC KABUSHIKI KAISHA, Tokyo (JP)

(21) Appl. No.: 10/382,124

(22) Filed: Mar. 5, 2003

(51) Int. Cl. B41J 11/26

(52) U.S. Cl. 400/613

(57) ABSTRACT

A printer comprising a printing section which performs a printing operation for receipt paper, a slider whose surface forms a paper conveying path for the conveyance of the receipt paper after printing, and a conveyance section which conveys the receipt paper after printing by means of a conveyor belt, the conveyor belt being stretched between and entrained on a driving pulley which is rotationally driven and a driven pulley and located at a position at which it comes into abutment against the slider through the paper conveying path, wherein the slider is formed so as to make almost uniform a pressing force applied from the conveyor belt, and the conveyor belt slips relative to the receipt paper when the movement of the receipt paper being conveyed is obstructed. According to this construction, when the movement of the receipt paper is obstructed, the receipt paper stands by between the conveyor belt and the slider, so that occurrence of paper jam can be surely prevented. Further, since it suffices to use a small number of components, it is possible to reduce the cost.

### BACKGROUND OF THE INVENTION

1. Field of the Invention

The present invention relates to a printer to be used for example in a commodity sale data processor or an automatic transaction machine to print predetermined matters on paper.

2. Discussion of the Background

In a commodity sale data processor such as POS terminal or ECR installed in a store or in an automatic transaction machine such as an automatic teller machine (ATM) or a cash dispenser (CD) installed in a financial organ or the like, there is mounted a printer for printing various transaction contents on paper such as receipt paper.

Generally, a printer is provided with a receptacle section for receiving and holding rolled receipt paper therein, a conveyance section for conveying receipt paper, a printing section for performing a printing operation for the receipt paper, a cutting section for cutting receipt paper as a single receipt, and a discharge section for discharging the printed and cut receipt from a receipt discharge port. In a printer disclosed in Japanese Patent Laid Open No. 10-218450, rolled receipt paper is cut and printed, then is conveyed in a vertically sandwiched state by means of conveyor belts.

In case of using any of various machines provided with such a printer, an operator sometimes tries to quickly recover a receipt discharged from the receipt discharge port. At this time, if the operator touches a receipt before cutting and continues to hold down the receipt, the movement of receipt paper in the conveyance direction is obstructed and there occurs paper jam. Also when the receipt discharge port is closed with the operator's hand or with any other thing, there occurs paper jam.

For preventing the occurrence of such paper jam, in a printer disclosed in Japanese Patent Laid Open No. 2000-143054, a paper guide member is provided in a receipt discharge port. With the paper guide member, even if a receipt which has been conveyed to a position near the receipt discharge port is obstructed its movement with fingers or the like, the receipt is allowed to bend and escape in a direction different from the receipt discharge direction by means of the paper guide member, so that the occurrence of paper jam can be prevented.

However, if the paper guide member is provided in the receipt discharge port as in the above 2000-143054 publication, it is necessary to ensure a mounting space for the paper guide member and a space for bending paper, thus giving rise to the problem that there occur restrictions in structure and design. In the case of a long receipt, the receipt protrudes from the paper guide member. Also in the case of a receipt strong in stiffness, the stiff receipt does not bend in a satisfactory manner, with the result that there occurs paper jam and it is difficult to surely prevent the occurrence of paper jam. Further, for conveying a receipt in a vertically sandwiched manner with conveyor belts as in the printer disclosed in the foregoing 10-218450 publication, it is necessary to provide both upper and lower conveyor belts and both upper and lower conveyor belt drive components, thus causing an increase of cost.

### SUMMARY OF THE INVENTION

Accordingly, it is an object of the present invention to provide a printer capable of reducing cost and surely preventing the occurrence of paper jam.

The above object of the present invention is achieved by a novel printer according to the present invention.

The novel printer of the invention comprises a printing section which performs a printing operation for receipt paper, a slider whose surface forms a paper conveying path for the conveyance of the receipt paper after printing, and a conveyance section which conveys the receipt paper after printing by means of a conveyor belt, the conveyor belt being stretched between and entrained on a driving pulley which is rotationally driven and a driven pulley and located at a position at which it comes into abutment against the slider through the paper conveying path, wherein the slider is formed so as to make almost uniform a pressing force applied from the conveyor belt, and the conveyor belt slips relative to the receipt paper when the movement of the receipt paper being conveyed is obstructed.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a perspective appearance view showing schematically the structure of a printer according to an embodiment of the present invention;

FIG. 2 is a side view in longitudinal section showing schematically the structure of the printer; and

FIG. 3 is a side view in longitudinal section showing schematically the structure of a discharge section in the printer.

### DETAILED DESCRIPTION OF THE PREFERRED EMBODIMENT

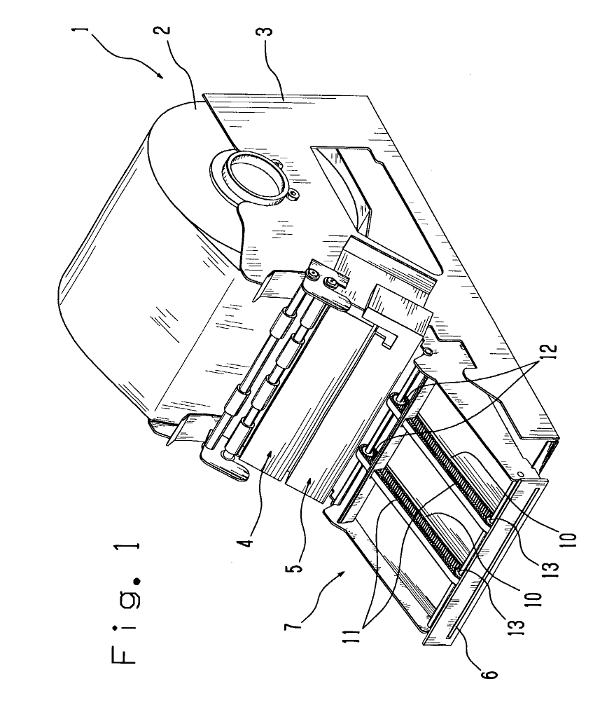

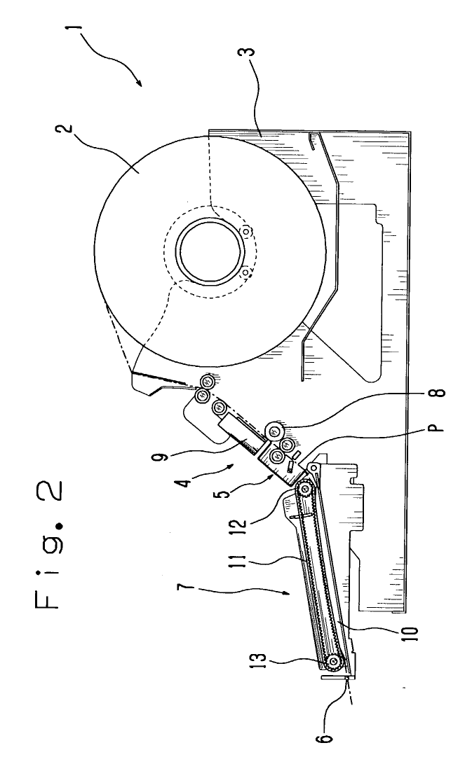

An embodiment of the present invention will be described hereinunder with reference to FIGS. 1 to 3. FIG. 1 is a perspective appearance view showing schematically the structure of a printer according to this embodiment and FIG. 2 is a side view in longitudinal section showing schematically the structure of the printer.

The printer, indicated at 1, is provided with a receptacle section 3 for receiving and holding rolled receipt paper therein, a printing section 4 for printing on the receipt paper 2, a cutting section 5 for cutting printed receipt paper 2 as a single receipt, and a discharge section 7 for discharging the receipt paper 2 after printing and cutting from a receipt discharge port 6.

The receptacle section 3 holds and accommodates rotatably the receipt paper 2 which is in a rolled state of long paper. A paper conveying path P for the conveyance of receipt paper 2 extends from the receptacle section 3, then through the printing section 4, cutting section 5 and discharge section 7, and communicates with the receipt discharge port 6.

The printing section 4 is provided with a platen roller 8 and a print head 9 opposed to the platen roller 8. The platen roller 8 is rotationally driven by a motor (not shown) which serves as a drive source. The print head 9 is mounted so as to be movable into contact with and away from the platen roller 8 through the paper conveying path P. For example, the print head 9 is a thermal printer head. In this case, the receipt paper 2 is thermal paper.

The cutting section 5 operates while being driven by a drive source (not shown). For example, the cutting section 5 is a cutter such as a rotary cutter or a guillotine type auto-cutter. The cutting section is positioned on an upstream side of the paper conveying path P with respect to the discharge section 7.

The discharge section 7 is provided with a slider 10 whose surface forms the paper conveying path P for the conveyance of receipt paper 2 after printing and is also provided with a conveyor belt 11 for the conveyance of receipt paper 2 in opposition to the slider 10. With these components, the discharge section 7 conveys receipt paper 2 after printing and discharges it from the receipt discharge port 6.

The receipt discharge port 6 is formed in a slit shape substantially in parallel with a front end portion of the receipt paper 2 being conveyed.

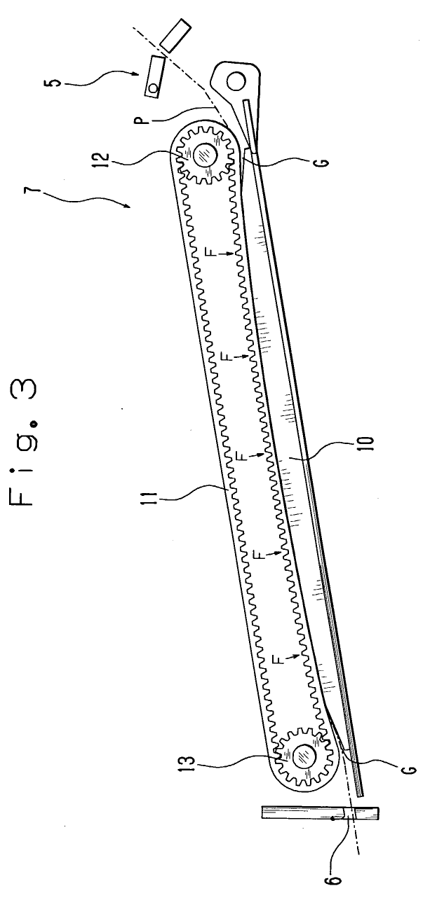

Next, a detailed description will be given below about the discharge section 7 in the printer 1. FIG. 3 is a side view in longitudinal section showing schematically the structure of the discharge section 7.

The conveyor belt 11 is stretched between and entrained on a driving pulley 12 which is rotationally driven and a driven pulley 13. The conveyor belt 11 is located at a position at which it comes into abutment against the slider 10 through the paper conveying path P. The driving pulley 12 is rotationally driven by a motor (not shown) which serves as a drive source. For example, the conveyor belt 11 is a toothed belt and the driving pulley 12 and the driven pulley 13 are also toothed pulleys, whereby slippage does not occur between the conveyor belt 11 and the pulleys 12, 13, thus permitting positive conveyance of the receipt paper 2. As a result, the conveyance of the receipt paper 2 can be stabilized. The conveyor belt 11, driving pulley 12 and driven pulley 13 function as a conveyance section.

The slider 10 is positioned under and in opposition to the conveyor belt 11 and supports the receipt paper 2 being conveyed. Thus, above the conveyor belt 11 there exist no parts that obstruct various works, including replacement and cleaning works for the conveyor belt, thus making it possible to carry out various works easily.

The slider 10 is formed so as to make almost uniform a pressing force F applied from the conveyor belt 11. More specifically, the slider 10 is formed so that its surface (the surface on the side abutted against the conveyor belt 11) which forms the paper conveying path P becomes arcuate in the paper conveying direction. That is, the slider surface which forms the paper conveying path P is arcuate when viewed from a side face in longitudinal section, whereby the pressing force F of the conveyor belt 11 against the surface of the slider 10 becomes almost uniform, so that the receipt paper 2 can be conveyed stably and with a weak pressing force F.

Further, the slider 10 is formed in such a manner that its surface opposed to the driving pulley 12 and the driven pulley 13 does not contact the conveyor belt 11. Consequently, a gap G is formed between the slider 10 and the portion of the conveyor belt 11 entrained on the driving pulley 12 and also between the slider and the conveyor belt portion entrained on the driven pulley 13. Thus, the slider 10 is not in abutment against the portions of the conveyor belt 11 entrained on both driving and driven pulleys 12, 13. As a result, the pressing force F of the conveyor belt 11 against the surface of the slider 10 becomes more uniform, whereby the conveyance of receipt paper 2 can be stabilized.

Next, when the receipt discharge port 6 is closed with an operator's hand or with any other thing, or when the operator continues to press down the receipt paper 2 for quick recovery of the receipt paper, the conveyor belt 11 slips relative to the receipt paper 2. Related relationships will be described below. In the following relationships:

Coefficient of friction between the conveyor belt and the receipt paper 2: μ(B)

Coefficient of friction between the slider 10 and the receipt paper 2: μ(S)

Pressing force of the conveyor belt 11 against the slider 10: F

Conveying force of the conveyor belt 11 for the receipt paper 2: W(B)

Hold-back force of the slider 10 for the receipt paper 2: W(S)

Stopping force of hand or any other thing against the receipt paper 2: W(H)

Stiffness of the receipt paper 2: K

The stopping force W(H) is a restricting force for restricting the movement of the receipt paper 2.

(1) The following relationship exists for the conveyance of receipt paper 2 by the conveyor belt 11:

W(B)>W(S)

where, W(B)=μ(B)×F

W(S)=μ(S)×F

Thus, μ(B)>μ(S) Expression (1)

(2) The following relationship exists when the receipt discharge port 6 is closed with the operator's hand or any other thing or when the operation continues to hold down the receipt paper 2 for quick recovery of the receipt paper:

W(H)≧W(B) Expression (2)

K>W(B) Expression (3)

If the stiffness K of the receipt paper 2 is weaker than the conveying force of the conveyor belt 11, there will occur paper jam because the receipt paper bends. The stiffness K of the receipt paper 2 depends greatly on the thickness of the receipt paper 2, but the type (thickness, etc.) of the receipt paper can be substantially specified in accordance with the purpose of use of the printer 1 (e.g., the printer is to be installed in a commodity sale processor or an automatic transaction machine). Therefore, the slider 10 and the conveyor belt 11 are constructed under conditions under which the relationships of Expressions (1), (2) and (3) exist. As a result, when the receipt discharge port 6 is closed with the operator's hand or any other thing or when the operator continues to hold down the receipt paper 2 for quick recovery of the receipt paper, the conveyor belt 11 can be slipped positively relative to the receipt paper 2.

The printer 1 is provided with a sensor (not shown) for sensing the occurrence of slippage of the conveyor belt 11. Upon sensing the occurrence of slippage of the conveyor belt 11 the printing operation of the printing section 4 is stopped.

In such a construction, the receipt paper 2 is conveyed to the printing section 4 by means of the platen roller 8 and predetermined matters are printed on the receipt paper 2 by the print head 9 in the printing section 4. The receipt paper 2 with the predetermined matters printed thereon is cut into a predetermined length in the cutting section 5, then the cut receipt paper is conveyed and discharged as a receipt from the receipt discharge port 6 in the discharge section 7. In this way a receipt is issued.

Usually the receipt paper 2 is conveyed between the conveyor belt 11 and the slider 10 under a substantially uniform pressing force F (a weak pressing force) of the conveyor belt. At this time, if the receipt discharge port 6 is closed with the operator's hand or any other thing or if the operator continues to hold down the receipt paper. 2 for quick recovery of the receipt paper, the conveyor belt 11 slips relative to the receipt paper 2 and the printing operation of the printing section 4 stops. As a result, the receipt paper 2 stands by between the conveyor belt 11 and the slider 10 and therefore paper jam does not occur. Thus, the occurrence of paper jam can be prevented positively.

Besides, since the discharge section 7 is constructed by the conveyor belt 11 and the slider 10, the number of components used is reduced and hence the cost can be kept low. Further, since rolled paper is used as the receipt paper 2, the time required for replacing the receipt paper can be shortened and it is possible to construct a space-saving printer 1.

What is claimed is:

1. A printer, comprising:
a printing section which performs a printing operation for receipt paper;
a slider whose surface forms a paper conveying path for the conveyance of the receipt paper after printing; and
a conveyance section which conveys the receipt paper after printing by means of a conveyor belt, the conveyor belt being stretched between and entrained on a driving pulley which is rotationally driven and a driven pulley and located at a position at which it comes into abutment against the slider through the paper conveying path, wherein:
the slider is formed so as to make almost uniform a pressing force applied from the conveyor belt, and
the conveyor belt slips relative to the receipt paper when the movement of the receipt paper being conveyed is obstructed.

2. A printer according to claim 1, wherein the surface of the slider forming the paper conveying path is formed so as to be arcuate in the paper conveying direction, the slider being constituted so as to make almost uniform a pressing force applied from the conveyor belt.

3. A printer according to claim 2, wherein the surface of the slider opposed to the driving pulley and the driven pulley is formed so as not to contact the conveyor belt.

4. A printer according to claim 1, wherein the conveyor belt and the slider are constructed so that the following conditions are established, assuming that a coefficient of friction between the conveyor belt and the receipt paper is μ(B), a coefficient of friction between the slider and the receipt paper is μ(S), a stopping force for stopping the movement of the receipt paper being conveyed is W(H), a conveying force of the conveyor belt for the conveyance of the receipt paper is W(B), and the stiffness of the receipt paper is K:
μ(B)>μ(S)
W(H)≧W(B)
K>W(B)

5. A printer according to claim 1, wherein the slider is disposed under the conveyor belt and supports the receipt paper being conveyed.

6. A printer according to claim 1, wherein the conveyor belt is a toothed belt.

7. A printer according to claim 1, wherein the receipt paper is in a rolled state of long paper.
